(19) United States
(12) Patent Application Publication
(10) Pub. No.: US 2023/0009262 A1
(43) Pub. Date: Jan. 12, 2023

(54) System for harvesting energy from fluids in motion

(71) Applicant: Rajat Sood, Sugar Land, TX (US)

(72) Inventor: Rajat Sood, Sugar Land, TX (US)

(21) Appl. No.: 17/676,299

(22) Filed: Feb. 21, 2022

Related U.S. Application Data
(60) Provisional application No. 63/219,303, filed on Jul. 7, 2021.

(51) Int. Cl. F03B 17/06; H04L 67/125; H02K 7/075; H02K 7/116; H02K 7/18

(52) U.S. Cl. CPC F03B 17/06; H04L 67/125; H02K 7/075; H02K 7/116; H02K 7/1823; F05B 2220/706

(57) ABSTRACT

A system and method for generating electricity from a flowing fluid, the system comprising a smart flow concentrator including an energy harvester, and a central computer and control system for controlling the operation of the smart flow concentrator and of the energy harvester. The energy harvester includes a drive foil section including a plurality of drive foils configured to generate electricity from the fluid flow passing through the smart flow concentrator.

### CROSS REFERENCE TO RELATED APPLICATIONS

The present application claims priority from provisional application 63/219,303 filed on Jul. 7, 2021 with the US Patent and Trademark Office which is incorporated herein by reference in its entirety.

### FIELD OF THE INVENTION

The present invention relates generally to production of electricity from the flow of fluids. More particularly, the present invention relates to a system for harvesting energy from fluids in motion by using real time control of non-rotary moving surfaces.

### BACKGROUND OF THE INVENTION

Conventional wind and water turbines require the use of rather large blades, which are difficult to build and transport.

Also, wind turbines need to be positioned way above the ground, lending to complicated and expensive installation structures and maintenance.

The present invention provides a system for harvesting energy from moving fluids by using moving parts that are smaller and easier to build and to transport.

### SUMMARY OF THE INVENTION

The present invention provides generally a system and method for energy extraction from flowing fluids and generation of electricity. The invention reduces the demands on very specialized and expensive construction materials.

According to an embodiment of the present invention, a system for generating electricity from a moving fluid is provided.

The system may comprise a smart flow concentrator including a smart intake, a smart outlet and an energy harvester section connected between the smart intake and the smart outlet. The system may also comprise a central computer and control system for controlling the operation of the smart flow concentrator and a sensor network including a plurality of sensors operatively coupled to the central computer and control system.

The walls of the smart intake may include a plurality of smart flow foil sails which are rotatable and controllable by the central computer and control system for changing their position for increasing or decreasing the fluid flow allowed to enter the energy harvester section. The smart intake may include large moveable foil sails that act like sails which accelerate and direct the fluid flow to the smart flow concentrator. The foil sails are controlled by the central computer and control system. The energy harvester section may include at least one energy harvester configured to generate electricity from the fluid flow.

The plurality of smart flow sails may rotate under the control of the computer system between a closed position wherein they form a continuous funnel shape wall and a fully opened position, offering the least resistance to the fluid flow.

The smart outlet may also include walls formed of a plurality of rotatable foils for controlling the fluid flow characteristics.

The at least one energy harvesters may be a pivoted design energy harvester.

The at least one energy harvester may be a winch design energy harvester.

According to an embodiment of the present invention, a method for generating electricity from a flowing fluid is provided, the method comprising:

providing the aforementioned system, passing the flowing fluid through the smart flow concentrator; controlling a position of each of the plurality of drive foils of the drive foil section of the at least one energy harvester to generate a reciprocating movement of the drive foil section; converting the reciprocating movement into a rotational movement of a rotor of a power generator; and generating, via the power generator, electricity.

The method may further include modifying at least one characteristic of the flowing fluid by controlling a position of each of the plurality of foil sails of the smart intake of the smart flow concentrator, passing the modified flowing fluid through the energy harvester section of the smart flow concentrator, controlling a position of each of the plurality of drive foils of the drive foil section of the at least one energy harvester to generate a reciprocating movement of the drive foil section; transmitting the reciprocating movement of the drive foil section to a crank mechanism; and converting, via the crank mechanism, the reciprocating movement into a rotational movement of a rotor of a power generator.

These and other features and advantages of the present invention will become better understood from the following drawings and detailed description of various embodiments of the invention

### BRIEF DESCRIPTION OF THE DRAWINGS

FIG. 1 is a simplified schematic overview of a system for generating electricity from a flowing fluid according to an embodiment of the present invention.

FIG. 2 is a simplified schematic overview of a system for generating electricity from a flowing fluid according to an embodiment of the present invention with an alternate drive design.

FIG. 3 is a front view of a smart flow concentrator according to an embodiment of the present invention, showing multiple drive foil sections of energy harvesters in the smart flow concentrator with some of the multiple drive foil sections turned off to accommodate with the available flow rate.

FIG. 4 is a cross sectional view of a smart flow concentrator showing the intake, the energy harvester section, and the outflow of the smart flow concentrator according to an embodiment of the present invention.

FIG. 5 is a simplified schematic of an energy harvester of a pivoted design according to an embodiment of the present invention.

FIG. 6 is simplified schematic of an energy harvester of a winch design according to an embodiment of the present invention.

FIG. 7 shows a drive foil section showing the various positions of the drive foils according to an embodiment of the present invention.

FIG. 8 shows a symmetrical foil design for the foil sails and the drive foils, according to an embodiment of the present invention.

FIG. 9 is a simplified flowchart of a method for generating electricity, according to an embodiment of the present invention.

FIG. 10 is a simplified flowchart of a method for generating electricity, according to an embodiment of the present invention.

### DETAILED DESCRIPTION OF THE INVENTION

The present invention relates generally to the generation of electricity from flowing fluids.

Unlike, existing methods and systems which employ wind turbines the present invention does not require tall towers and large rotary blades.

The present invention provides a system and method for extracting energy and convert it to electricity from flowing fluids, such as, for example, wind, waves at shore, waves in deep water, tides, tidal flows, estuary flows, rivers, streams and ocean currents. An object of the present invention is to generate electricity from flowing fluids without the very complex logistics of building tall towers, transporting large blades which are necessary for methods using wind turbines.

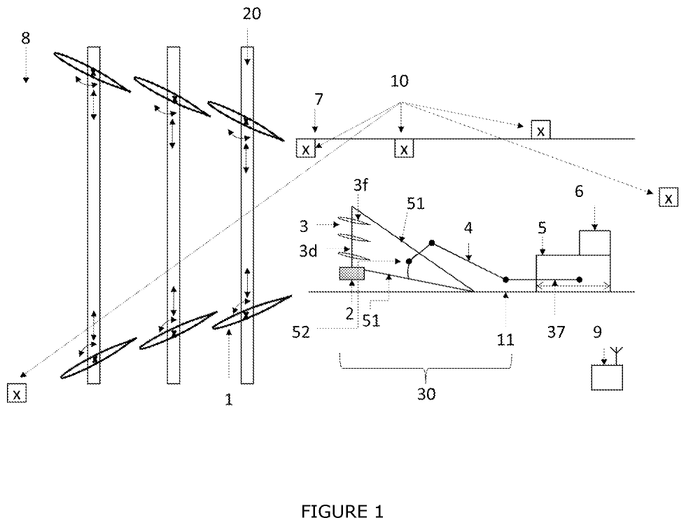

Referring to FIG. 1, a system for generating electricity from a moving fluid is provided. The system may comprise a smart flow concentrator generally designated with numeral 7, a network of sensors 10 and a central computer and control system 9 operably connected to the plurality of sensors and the various moving parts of the smart flow concentrator for real time control of the moving parts of the smart flow concentrator 100.

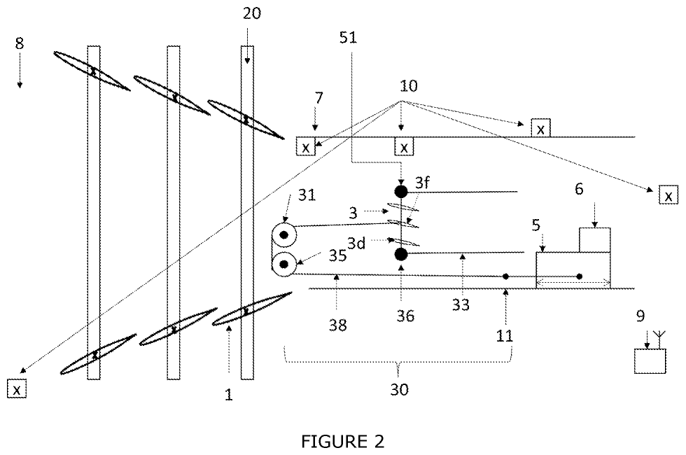

The smart flow concentrator 100 includes a smart intake 8, a smart outflow 14 (See FIG. 2), and an energy harvester section 11 connected between the smart intake and the smart outlet 14. The central computer and control system 9 may be operably connected to the plurality of sensors 10 and the various moving parts (e.g., the various foils, movement transmission lines) of the smart flow concentrator 7 for real time control of the moving parts of the smart flow concentrator 7. The central computer and control system 9 orchestrates movement and positioning of every moving part based on real time information received from the sensors to ensure a continuous reciprocating movement is generated, that the reciprocating movement is converted into a rotational movement, and that electricity is generated from the rotational movement.

The central computer and control system may employ an AI engine to learn flows and be able to control the flow intakes, outflow, and the multiple drives. Each sub system may have its own control real time. For example, a drive control sub-system may move the drives based on an algorithm to only create strokes in chosen directions. These movements controlled in the chosen directions will be synthesized to form a smooth continuous reciprocating movement for producing power. Multiple drives may be deployed and may be controlled based on an algorithm to ensure multiple drives are spaced apart appropriately in their respective cycles to smoothen the energy production.

The multiple drives under the supervisory control of the central computer and control system may function similarly to the reverse of an internal combustion engine where energy is being extracted by the pistons. However, a major difference is that the internal combustion engine pistons have a top dead center and a bottom dead center for their strokes. In the present invention system, there is no concept of a top and bottom dead center. Instead, the transmission is controlled via the central computer and control system for establishing the parameters of each stroke.

The walls of the smart intake 8 may include a plurality of foil sails 1 controllable by the central computer and control system 9 for increasing or decreasing the fluid flow allowed to enter the energy harvester section 11. The foil sails 1 may be rotatable, i.e., they may be capable of a rotating movement under the control of the central computer and control system 9. The foil sails 1 may rotate about a vertical axis. The foil sails 1 may be capable of moving closer together or further away from each other under the control from the central computer and control system. In an embodiment, the foil sails may be capable of both a rotational movement and may also move closer or further apart from each other under the control of the central computer and control system 9.

The energy harvester section 11 may include at least one energy harvester 30 configured to generate electricity from the fluid flow. Preferably, the energy harvester section 11 may include a plurality of energy harvesters 30.

The smart outlet 14 may also include walls formed of a plurality of foil sails 1 for controlling the fluid flow characteristics. The foil sails 1 of the smart outlet 14 may be of the same type as the foil sails 1 of the smart intake 8.

The plurality of the foil sails 1 of the smart intake 8 may form a funnel shape wall when the foil sails 1 are controlled to be at a first position. The smart intake 8 may have a funnel shape having a larger opening away from the energy harvester section 11. The foil sails 1 making the walls of the smart intake 8 may have an oval shape or a plane wing cross section shape when viewed from a top view. In an embodiment the foil sails 1 may have a symmetrical foil design. The foil sails 1 may have a rectangular shape from a side view. The foil sails 1 may be configured to touch, lock together to form a continuous wall at an initial default position. The foil sails 1 can be rotated to create openings between them, thus changing the fluid flow entering the harvester energy section 11. By opening and closing the foil sails 1 the amount of fluid flow to enter the harvester energy section 11 may be controlled. The foil sails 1 may be made of any suitable material. Each foil sail 1 may be rotatably mounted on a support structure 20 also referred to as the intake foil housing and hydraulics frame. The intake foil housing and hydraulics frame 20 may include a plurality of rods forming a structural skeleton supporting the foil sails 1. For example, FIG. 1 shows bars extending vertically, each holding two foil sails 1, one foil sail at each one of its ends. The bars may be connected to each other and to the energy harvester section 11 via any suitable structural elements (not shown) forming a support skeleton frame for holding the foil sails 1 of the smart intake 8. A similar structure may be employed for the outflow 14.

The energy harvester section 11 may have a generally rectangular box shape made of solid and flat side, top and bottom walls, while the front and rear of the energy harvester section 11 are open and connected to the smart intake and smart outlet, respectively. In another example (not shown), the energy harvester section 11 may have a generally cylindrical shape made of a solid and flat side wall, while the front and rear of the energy harvester section 11 are open and connected to the smart intake and smart outlet, respectively. Other shapes may also be used. The energy harvester section 11 may include at least one energy harvester 30. The energy harvester section 11 may preferably include a plurality of energy harvesters 30. Each energy harvester 30 may be of a pivoted design energy harvester. Each energy harvester 30 may be of a winch design energy harvester.

According to an embodiment of the present invention a system for generating electricity from a flowing fluid is provided, the system comprising a sensor network 10, a central computer and control system 9 with software for real time control and optimization, a smart flow concentrator 7, and a plurality of energy harvesters of a pivoted design including multiple drive foil sections 3, a transmission 4, a gearbox 5, and a power generator 6. In operation, the drive foil sections 3 may move up and down because of the fluid flow and this movement may then be converted into a reciprocating motion that is transmitted to the gear box 5. The gear box 5 may then convert the reciprocating motion to a rotational motion which in turn may be converted to an electrical output at the power generator 6.

Referring to FIG. 1, the sensor network includes a plurality of sensors 10 for detecting multiple real time parameters including pressure, temperature, fluid flow properties, position of the drive foils and of the foil sails, and the like. The sensors 10 (also referred to herein as the nodes of the network) may be placed at the entrance of the smart flow concentrator, before the energy harvester, after the energy harvester, in the outflow and also on the outside of the smart flow concentrator. The sensors may be used to control the smart flow intake foil sails 1, and the drive foils 3f of the energy harvester 11.

The sensor network employs a plurality of sensors 10 for monitoring fluid flow outside and inside the smart flow concentrator intake and outflow, inside the energy harvester section 11 before and after each energy harvester unit 30, and each drive foil 3f on each drive 3.

Additional position sensors may be used over each drive, and moving assembly.

All sensors 10 may supply real-time information to the central computer and control system 9, using a network, for real time control and optimization of the smart flow concentrator 7 and the energy harvester 30. The central computer and control system 9 may control multiple energy harvesters 30 contained in a single smart flow concentrator 7. The central computer and control system 9 is capable to control each energy harvester 40 and each element of each drive foil section 3f independently to produce the maximum power.

The computer 9 may preferably be configured to control all moving drive foils 3f and assemblies independently based on learning models and artificial intelligence to be able to use the best setting for maximum safe energy harvesting.

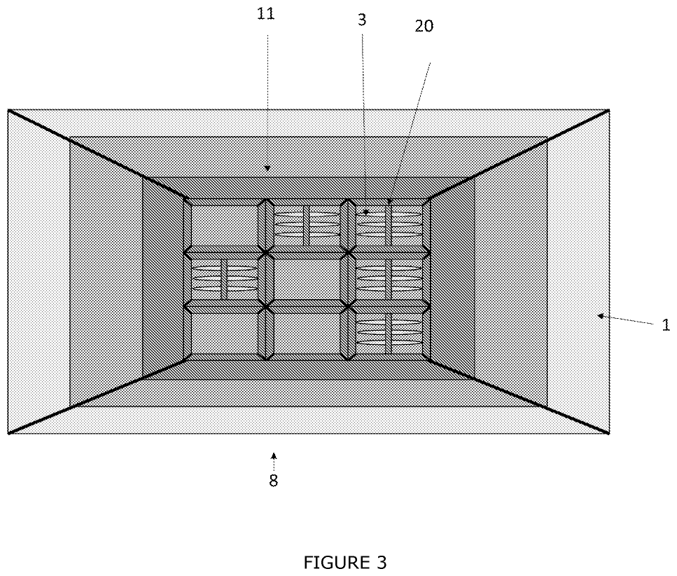

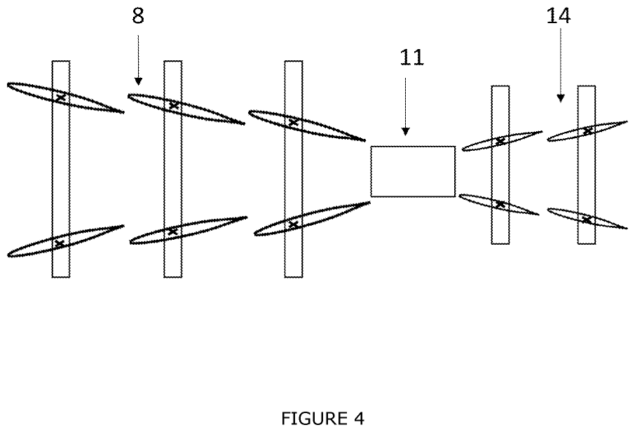

Referring now to FIGS. 3 to 5 a smart flow concentrator 7 is shown according to an embodiment of the present invention. The smart flow concentrator 7 includes a smart inflow (or intake) 8, a middle section or the energy harvester section 11 for housing the energy harvesters 30, the gear box 5 and the power generator 6, and a smart outflow 14. The energy harvester section 11 includes at least one energy harvester 30 (see FIGS. 1 and 2). Preferably, the energy harvester section 11 houses a plurality of energy harvesters 30. Each energy harvester 30 captures the energy of the moving fluid and converts it to a reciprocating movement of a reciprocating transmission 37 that in turn is converted to a rotational movement in the gear box 5. The rotational movement from the gear box 5 is then converted to electricity in the power generator 6. In an embodiment, a plurality of reciprocating transmissions 37 from a corresponding plurality of energy harvesters 30 may be coupled to a single gear box 5. The gear box 5 provides the means for converting the reciprocating movement of the transmission generated by the energy harvester 30 into a rotational movement. The power generator 6 contains a rotor coupled to the gear box 5 and a stator so that as is well-known will generate electricity by the turning of the rotor inside the stator. The electricity from the power generator 6 will then transferred via a cable to any suitable device or system for storing electricity or directly to an electricity network.

The smart flow intake 8 may include a plurality of sensors 10. Each wall of the smart flow intake 8 may include several foil sails 1 that are controlled by the central computer and control system unit 9. The smart flow foil sails 1 may form concentric rectangles or squares. Each smart flow foil sail 1 can be controlled individually. The effective angle of the smart flow foil sails 1 can be changed to provide improved fluid flow with increased speed and reduced turbulence to optimize energy extraction. The smart flow foil sails 1 form a barrier and direct the flow like a sail. The larger the area of the smart flow foil sails 1, the greater the output of the energy harvester.

The smart flow intake 8 makes use of the phenomena of the ground effect and also creates a smart venturi intake. The smart flow foil sails of the walls of the smart flow intake are controlled by the central computer and control system. Specifically, the central computer and control system may control the angle of each of the smart flow foil sails for controlling the fluid flow in order to optimize the fluid flow for energy extraction.

The smart outlet 14 also includes walls formed of a plurality of rotatable, smart flow foil sails 1 for controlling the flow of the fluid into the energy harvester section 11 and the fluid flow characteristics.

As it can be seen better in FIG. 3, the smart flow sails in a first closed position may form a funnel shaped wall towards the energy harvester section 11 including a plurality of drive foil sections 3 of a corresponding plurality of energy harvesters 30. An intake foil housing and hydraulics structure 20 provides support and the required hydraulics for the smart flow foil sails for their operation.

The smart flow foil sails 1 may have an oval shape from a top view, and a rectangular shape from a side view. The smart flow foil sails 1 may be configured to touch, lock together to form a continuous wall at an initial closed position forming a continuous funnel shape wall. The smart flow foil sails 1 can be rotated to create openings thus reducing the fluid flow entering the harvester energy section 11. By opening and closing the smart flow foil sails 1 the amount of fluid flow to the harvester energy section 11 is controlled. The smart flow foil sails 1 may be made of any suitable material. Each smart flow foil sail 1 may be rotatably mounted on an intake foil housing and hydraulics structure 20 configured to hold the smart flow foil sails and provide the required hydraulic fluids and control lines for their operation under the supervision of the central computer and control system 9. The intake foil housing and hydraulics structure 20 may include, for example, a plurality of structural bars or rods connected to each other and to the energy harvester section 11 via any suitable structural elements.

The central computer and control system 9 may change the angle of the smart flow foil sails 1, for example, so that the smart flow concentrator 7 may increase the fluid speed and reduce fluid turbulence for better energy extraction. The system may optimize fluid flow and harvests the fluid energy of the moving fluid according to the following equation 1:

A1*V1=A2*V2 equation 1

wherein A1*V1 is the effective fluid flow into the smart flow intake, and A2 and V2 are the area and fluid velocity at the energy harvester 30, respectively. A1 is the cross-sectional area of the entire intake foils exposed to the fluid flow combined and V1 is the velocity of the fluid outside the smart flow concentrator. A2 is the cross-sectional area of the drive section which is much smaller.

By applying Bernoulli's principle and the equation of continuity, the velocity V2 in the smart flow concentrator will be increased. In an example, the area A1 of the intake foil area converted to a cube has a cross-section taken is 20 m by 20 m and the ambient fluid velocity V1 is 6 m/s. If the cross-section of the smart flow concentrator is 6 m by 6 m, then the velocity of the fluid flowing through will be 66 m/s according to equation 1 solved for V1 which becomes:

V1=(A1V1)/A2 equation 2

Thus, at an average beach wind, the smart flow concentrator will generate winds of 66 m/s or 149 mph.

The smart flow concentrator outflow 14 also consists of several concentric rectangles or squares with sails, exactly like the intake of the smart flow concentrator to complete the Venturi effect.

Energy Harvester

Pivoted Drive

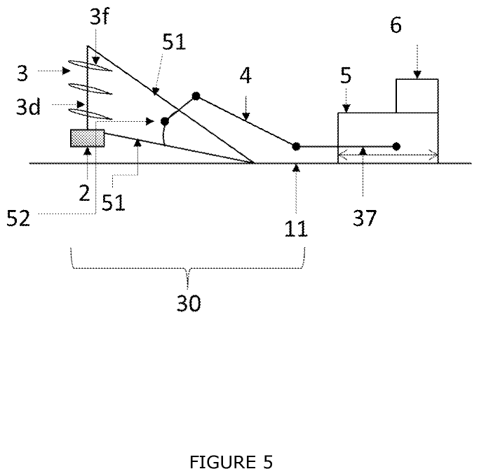

Referring to FIG. 5, an energy harvester may have a pivoted energy harvester design comprising an array of smart drive foils 3f generally referred to as a drive foil section 3. The smart drive foils 3f may be arranged in the drive foil section 3 to be spaced apart from each other at regular intervals. The movement of each of the smart drive foils 3f may be contained (restricted) between two positions. Specifically, depending on the positioning of the smart drive foils 3f of the drive foil section 3f, the moving fluid which passes through the energy harvester section 11 of the smart concentrator 10 may provide either a lift or a drag on each one of the smart foils 3f, causing them to move in one direction. This movement of the smart drive foils 3f moves the drive foil section 3 in an up and down movement. This reciprocating movement of the drive foil section 3 is converted to a rotational movement of the rotor of the power generator 6. As the rotor is turned within the stator of the power generator the kinetic energy is transformed into electricity output from the power generator 6. The conversion of the up and down movement of the drive foil section 3 to rotational can be done by any suitable mechanism including for example a crankshaft mechanism schematically shown as gear box 5 in FIGS. 1 and 2.

The power generator 6 may include a rotor which is coupled to the crankshaft of the gear box 5 and a stator wherein the reciprocating movement of the reciprocating transmission 37 is converted via the gearbox 5 into a rotational movement of the rotor within the stator of the power generator to generate electricity. The sensors 10 will convey the physical characteristics of the fluid flow to the central computer and control system 9 which are needed to optimize the controlling of the various elements of the movement of the drive foils 3f of the drive foil section 3. Each drive foil 3f could be moved independently or as a group to provide a lift or a drag or be in a neutral position. The flow parameters are the flow velocities along streamlines, temperature of the fluid as well the pressure at the measuring point 10.

The drive foil section 3 may include a vertical rod 3d on which the drive foils 3f are mounted. The drive foil section 3 may also include a counterweight 2 which is attached to the lower end of the vertical rod 3d. The drive foil section 3 with the counterweight 2 may be movably secured to a wall of the energy harvester section 11 via a vertical drive assembly 51 or frame 51. The vertical drive assembly 51 may allow free up and down movement of the drive foil section 3. The drive foil section 3 is coupled to gearbox 5 of a power generator 6 via a mechanism for converting the up and down movement of the drive foil section 3 to a rotational movement of the rotor of the power generator 6. For example, the vertical drive assembly 51 may be coupled via a coupling 52 and a transmission rod 4 to a reciprocating transmission 37 which is in turn coupled to the gearbox 5. The vertical drive frame 51, the coupling 52, and the transmission rod 4 convert the up and down movement of the drive foil section 3 to the reciprocating movement of the reciprocating transmission 37. The gearbox 5 converts the reciprocating movement of the reciprocating transmission 37 to the rotational movement of the rotor of the power generator 6 for generating electricity. Thus, the up and down movement of the vertical drive assembly 51 is converted to a reciprocating movement of the reciprocating transmission rod 37 which is operatively coupled to the gear box 5. The computer 9 may control the orientation of the drive foils 3f to create a lifting force at one time and at another time may reduce the lifting force at thus allowing the counterweight to bring the vertical drive assembly to a lower position. The computer 9 may constantly adjust the orientation of the drive foils 3f based on the characteristics of the fluid flow based on the data received by the sensors. The gear box 5 may include a crankshaft mechanism. A plurality of reciprocating transmission rods 37 may be operatively coupled to the gear box 5.

In operation, the fluid flow with the drive foils 3f positioned by the central computer and control system 9 at a lift generating position makes the drive foil section 3 to move up at a first time. Then, the central computer and control system 9 may change the positioning of the drive foils 3f to a drag generating position which together with the counterweight 2 may cause the drive foil section 3 to move down at a second time.

The central computer and control system 9 controls the orientation of the drive foils 3f to create a lifting force at the first time and then reduce the lifting force at the second time allowing the counterweight 2 to bring the drive foil section 3 lower to its original position. The computer 9 may constantly adjust the orientation of the drive foils 3f based on the characteristics of the fluid flow based on the data received by the sensors 10 to ensure smooth movement of the drive foil section 3.

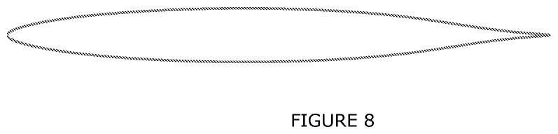

Each drive foil 3f may have a constant width and will not have any tapering on the edges. For example, each foil may have a symmetrical foil shape as shown in FIG. 8. Each drive foil 3f may also have a flap section which will be used to provide additional drag, lift or stability during operation.

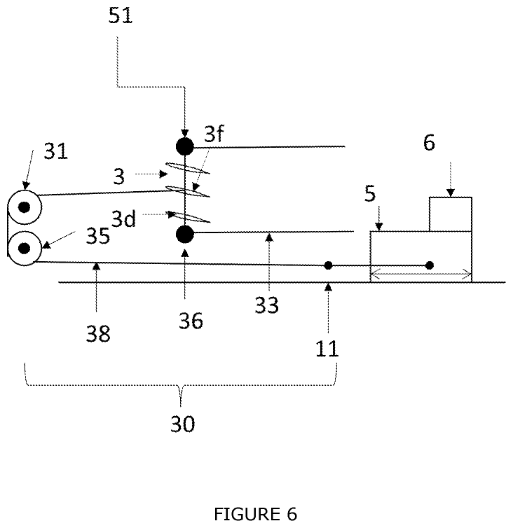

Referring to FIGS. 2 and 6, the energy harvester 30 may have a winch moving assembly design. In this design, the drive foils 3f of the drive foil section 3 are attached to a vertical rod 3d which has guide wheels 36 on both of its ends. The guide wheels 36 are configured to move on the guide rails 33. The drive foils 3f, the vertical rod 3d, the guide wheels 36 and the guide rails 33 form a moving assembly which is connected via a winch cable 38 and a winch drive 31 to the reciprocating transmission 37. The reciprocating transmission 37 is coupled at its other end to the gear box 5. The roles of the moving assembly are to supply the hydraulics to the drive foils, provide the control lines for positioning the sensors, provide a pivoting point for each of the drive foils to attach to the drive rod, provide a movement path with a bottom point and a transmission section, and keep the foil section vertical at all times. The moving assembly may have a frame including the vertical rod 3d that the drive foils 3f are seated on. The drive foils 3f with the vertical rod 3d may also be referred to as the drive foil section 3.

FIGS. 2 and 6 show a winch type energy harvester 30 in a horizontal orientation as it may be positioned within the energy harvester section 11. The guide rails 33 may be secured to the side walls. The winch mechanism 31 serves to drive the foil section to return to its starting point.

The motion of the drive foil section 3 may resemble that of a jellyfish swimming, with an opening and closing of the drive foil section, creating a reciprocating motion.

The winch moving assembly has the same roles as the pivoted vertical assembly. The roles of the assembly are to supply the hydraulics to the foils, provide the control lines and position sensors, provide a point for each of the foils to attach to provide a movement path with a bottom point and a maximum high point, and to provide an anchor point for the winch section

The moving assembly on which the drive section is seated on can move along the guiderails because of the lift and drag forces exerted on the drive foils 3f of the drive foil section 3 from the fluid flow. For example, the moving assembly may move back and forth from a first to a second position along the guiderails. Or also, as an example, the moving assembly may move up and down (not shown) along the guide rails.

Drive Foil Section and Power generation

The power generation for each reciprocating motion may be estimated according to the following equation:

Power=(½*A*p*CL*V3)+(½*A*ρ*Cd*V3),

wherein
A is the total area for foils in the harvester section
ρ is the density of the fluid,
CL and Cd are the lift and drag coefficients of the drive section, and
V3 is the velocity of the fluid flowing through the drive section

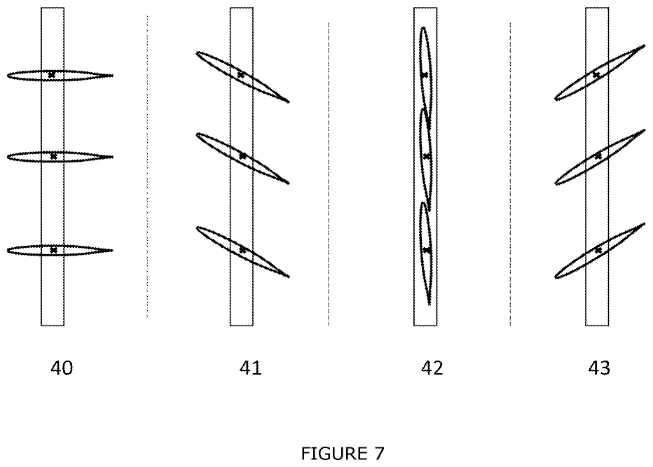

Referring to FIG. 7, the moving assembly may have several simplified moving positions for the foils.

The neutral position 40-this lets fluid flow through with neutral lift;

The lifting position 41-this provides maximum lift from the foils;

Fully obstructed flow position 42-providing the largest transfer of fluid force to the drive section;

The drag position 43-that brings the drive back to the original position.

Multiple drives and moving assemblies may work out of phase with neighboring ones, thus making use of the back pressure created by neighboring drive sections and may also help in keeping the noise levels down.

The reciprocating transmission 37 may transfer power via its reciprocating motion to the gearbox 5. The reciprocating transmission 37 may be a crankshaft operably coupled to the moving assembly or to the winch assembly.

The gearbox 5 may be any device suitable for converting the reciprocating motion to rotary motion. The gearbox 5 may create a unidirectional rotary motion from the power from the reciprocating motion. The gearbox 10 may have sensors connected to the main computer that will select the appropriate gear ratio for supplying optimal power to the power generator, with or without the use of a flywheel.

The rotary motion may run the power generator 6 either directly or with the use of one or many flywheels for generating electricity.

The system may be used to generate electricity from wind, and water.

According to an embodiment, the system may be used for power generation from wind. Compared to existing rotary wind turbines, the present invention system offers many technical advantages and cost savings. For example, for wind turbines there is a need to raise them high above the ground so that they can operate with stronger winds. For example, most wind turbine towers are over 100 m high. Also, over the years it has been a norm to get larger and larger blades with spans often times exceeding 80 m.

Compared to wind turbines, the present invention system may simplify construction since it may not employ a high tower or large wind turbine blades.

The present invention system also may make use of the ground effect to combat turbulent flows.

The present invention system may also reduce operational and maintenance costs because it employs equipment which are positioned on land without any large supporting tower like the ones used for air turbines.

In an application, the present invention system may be employed in urban areas, for example, by installing it between large buildings. It may also be installed in buildings such as skyscrapers which have gap floors for the purpose of creating a wind channel to reduce pressure on the structure. According to this application a gap floor of a skyscraper may include the smart flow concentrator 7 to generate electricity from wind passing through the smart flow concentrator at increased speeds. In addition to the acceleration of the wind speed achieved because of the design characteristics of the smart flow concentrator, the overall building with the gap floor will act as an additional wind accelerator directing the wind flowing against the building through the gap floor and the smart flow concentrator 7.

In another embodiment, the present invention system may be used to generate electricity from water flow. With the density of water being many times that of the air, the system may perform more efficiently when the fluid flowing through the smart flow concentrator is water than air. For example, in a water application the size of the energy harvester section 11 and of the smart flow concentrator 7 may be substantially reduced because water has a density that is approximately 830 times greater than the density of air.

In an embodiment of a water application of the present invention system, the smart flow concentrator may be securely positioned on a seabed location. For example, it may be anchored on the seabed location by multipoint anchors or any other suitable means. Preferably, the seabed location may be selected to be in a place of the seabed where an ocean current is strong and abundant.

In yet another embodiment of a water application, the system may be used to generate power from sea waves. For example, when a location closer to the shore is selected, the drive foil section may be controlled to operate power only in one direction to catch the motion of the waves. For optimizing energy capture and energy transfer the central computer and control system will control the position of the foils based on the water conditions such as the type of the waves, frequency and amplitude of the waves and local conditions. The depth of the water may play a role in this particular embodiment.

In deeper waters the drive foil sections 3 may be controlled to operate in both directions of waves motion as they move towards the shore at a first time and then retreat away from the shore at a second time.

When water is flowing in a river, stream or a channel, the system can be used as an underwater installation, a submersible installation, or as a surface installation. The system could be used downstream of hydroelectric plants as well.

Depending on the gradient of the flow, one or many systems could work in tandem.

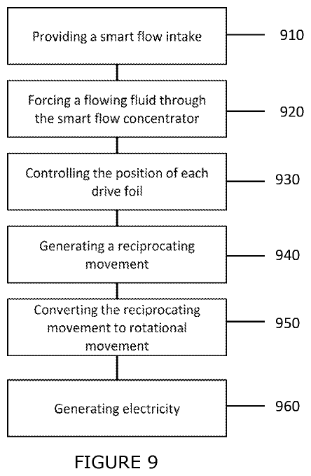

Referring now to FIG. 9, according to an embodiment of the present invention, a method for generating electricity from a flowing fluid may include providing a smart flow concentrator 910, passing the flowing fluid through the smart flow concentrator 920, controlling a position of each of the plurality of drive foils of the drive foil section of the at least one energy harvester 930 for generating a reciprocating movement of the drive foil section 940, converting the reciprocating movement of the drive foil section to a rotational movement of a rotor of a power generator 950, and generating electricity 960.

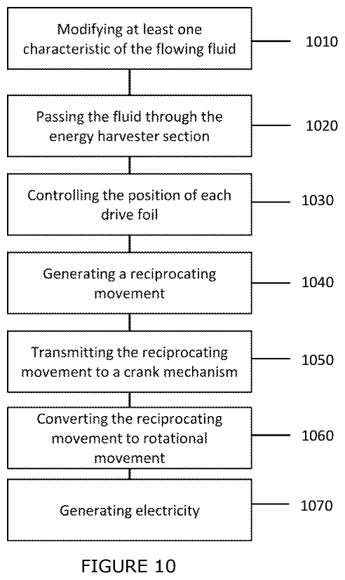

Referring to FIG. 10, the method may further include modifying at least one characteristic of the flowing fluid 1010. This may be done by controlling a position of each of the plurality of foil sails of the smart intake of the smart flow concentrator. The method may further include passing the modified flowing fluid through the energy harvester section 1020, and controlling a position of each of the plurality of drive foils 1030 of the drive foil section of the at least one energy harvester to generate a reciprocating movement of the drive foil section 1040. The method may further include generating a reciprocating movement 1040, transmitting the reciprocating movement of the drive foil section to a crank mechanism 1050, converting, via the crank mechanism, the reciprocating movement into a rotational movement of a rotor of a power generator 1060, and generating electricity 1070.

The modifying of the at least one characteristic of the flowing fluid may include the central computer and control system 9 calculating a value for the at least one characteristic of the flowing fluid via data collected by the at least one sensor of the plurality of sensors and transmitted to the central computer and control system. The sensors may be positioned at the smart intake, the energy harvester section, and the smart outlet.

The central computer and control system 9 may analyze the received data, determine an optimum position of each of the sail foils 1 of the smart intake 8 for obtaining an optimum value for the at least one characteristic, and control the positioning of each of the sail foils 1 of the smart intake 8 to the determined optimum position.

The at least one characteristic of the flowing fluid may be at least one of a fluid velocity, direction of the flowing fluid, turbulence, density, and temperature.

The determining of the optimum value for the at least one characteristic may include the central computer and control system taking into account a geometry of the foil sails 1.

The controlling of the position of each of the plurality of the drive foils 3f of the drive foil section 3 of the at least one energy harvester for generating a reciprocating movement of the drive foil section may include:

the central computer and control system 9 receiving data about the at least one characteristic of the flowing fluid, and determining a target position for each of the drive foils of the drive foil section taking into account the received data about the at least one characteristic of the fluid flow and at least one characteristic of a geometry of the drive foils for increasing or decreasing a lift generated by each of the drive foils.

Although the present invention has been described in reference to specific examples and embodiments, it should be understood that these are only provided for enabling a person with ordinary skill in the art to fully understand the present invention, however, they are not intended to only limit the present invention to the described examples and embodiments. Many other variations, examples, and embodiments may be readily envisioned by the skilled person after having read the present disclosure of the present invention without departing from the scope and spirit of the present invention.

What is claimed is:

1. A system for generating electricity from a flowing fluid, the system comprising:
a smart flow concentrator including at least one energy harvester, and
a central computer and control system for controlling the operation of the smart flow concentrator and of the at least one energy harvester,
wherein the at least one energy harvester includes a drive foil section including a plurality of drive foils configured to generate a reciprocating motion from the fluid flow passing through the smart flow concentrator, and wherein the reciprocating motion is transmitted to a power generator for generating electricity.

2. The system of claim 1, further comprising a sensor network including a plurality of sensors positioned at a plurality of locations of the smart flow concentrator, the sensors being operatively coupled to the central computer and control system;
wherein the smart flow concentrator includes a smart intake, a smart outlet and an energy harvester section mechanically connected between the smart intake and the smart outlet and in fluid communication with the smart intake and the smart outlet;
wherein the walls of the smart intake include a plurality of foil sails controllable by the central computer and control system for increasing or decreasing the fluid flow allowed to enter the energy harvester section, and
wherein the energy harvester section houses the at least one energy harvester.

3. The system of claim 2, wherein the plurality of the foil sails are rotated under the supervising control of the central computer and control system to a plurality of positions between a fully opened and a fully closed position to allow more or less fluid flow through the energy harvester section of the smart flow concentrator for optimizing an amount of energy of the flowing fluid that is harvested and converted to electricity by the smart flow concentrator.

4. The system of claim 2, wherein the energy harvester section has a generally box shape made of solid and flat side, top, and bottom walls, and wherein a front and rear of the energy harvester section are open and connected to the smart intake and smart outlet, respectively.

5. The system of claim 2, wherein the energy harvester section has a generally cylindrical shape made of a solid side wall, and
wherein a front and rear of the energy harvester section are open and connected to the smart intake and smart outlet, respectively.

6. The system of claim 1, wherein the at least one energy harvester is of a pivoted design.

7. The system of claim 1, wherein the at least one energy harvester is of a winch design.

8. The system of claim 1, wherein the fluid is at least one of air flowing through a gap floor of a building, a sea water current, sea waves, or river water.

9. The system of claim 1,
wherein the plurality of the drive foils of the drive foil section are movably mounted on a support and spaced apart from each other at a regular interval,
wherein the drive foils have a shape of a hydrofoil or an airfoil depending on whether the fluid is water or air and are movable to change their orientation relative to a flow of the fluid to generate different levels of lift and drag so that the drive foil section is moved in a generally reciprocating movement,
means for converting the reciprocating movement of the drive foil section to a rotational movement of a rotor of a power generator for generating electricity, and
wherein the system outputs the generated electricity to a device.

10. The system of claim 8,
wherein the drive foil section includes a counterweight for contributing to the reciprocating movement of the drive foil section, and
wherein each of the drive foils has a symmetrical foil design.

11. The system of claim 8,
wherein the drive foil section includes wheels movable on rails positioned on one or more walls of the energy harvester section and a winch mechanism, and
wherein the means for converting the reciprocating motion to the rotational motion of the rotor of the power generator include a crank mechanism including a crank coupled at one end to the reciprocating drive foil section and at another end thereof to the rotor of the power generator via one or more coupling members.

12. The system of claim 11, wherein the one or more coupling members includes a winch for directing the reciprocating movement of the drive section to the crank mechanism.

13. The system of claim 12, wherein a plurality of drive foil sections of the plurality of the energy harvesters are coupled to a single crank.

14. A method for generating electricity from a flowing fluid, the method comprising:
providing the system of claim 1,
passing the flowing fluid through the smart flow concentrator;
controlling a position of each of the plurality of drive foils of the drive foil section of the at least one energy harvester to generate a reciprocating movement of the drive foil section;
converting the reciprocating movement into a rotational movement of a rotor of a power generator; and
generating, via the power generator, electricity.

15. A method for generating electricity from a moving fluid, the method comprising:
providing the system of claim 2,
modifying at least one characteristic of the flowing fluid by controlling a position of each of the plurality of foil sails of the smart intake of the smart flow concentrator;
passing the modified flowing fluid through the energy harvester section of the smart flow concentrator;
controlling a position of each of the plurality of drive foils of the drive foil section of the at least one energy harvester to generate a reciprocating movement of the drive foil section;
transmitting the reciprocating movement of the drive foil section to a crank mechanism;
converting, via the crank mechanism, the reciprocating movement into a rotational movement of a rotor of a power generator; and
generating, via the power generator, electricity.

16. The method of claim 15, wherein the modifying of the at least one characteristic of the flowing fluid includes:
the central computer and control system calculating a value for the at least one characteristic of the flowing fluid via data collected by the at least one sensor of the plurality of sensors positioned at the smart intake, the energy harvester section, and the smart outlet, said data being transmitted to the central computer and control system;
the central computer and control system analyzing the received data, determining an optimum position of each of the sail foils of the smart intake for obtaining an optimum value for the at least one characteristic, and controlling the positioning of each of the sail foils of the smart intake to the determined optimum position.

17. The method of claim 15, wherein the at least one characteristic of the flowing fluid is at least one of a fluid velocity, direction of the flowing fluid, turbulence, density, and temperature.

18. The method of claim 15, wherein the determining of the optimum value for the one characteristic includes the central computer and control system taking into account a geometry of the foil sails.

19. The method of claim 15, wherein the controlling of the position of each of the plurality of the drive foils of the drive foil section of the at least one energy harvester for generating a reciprocating movement of the drive foil section includes:
the central computer and control system receiving data about the at least one characteristic of the flowing fluid, and determining a target position for each of the drive foils of the drive foil section taking into account the received data about the at least one characteristic of the fluid flow and at least one characteristic of a geometry of the drive foils for increasing or decreasing a lift generated by each of the drive foils.

20. The method of claim 15 further comprising installing the system inside an air gap floor of a building, wherein the smart flow concentrator is configured to extract electrical energy from wind accelerated by passing through the air gap floor of the building and the smart flow concentrator.
